(19) United States
(12) Patent Application Publication
(10) Pub. No.: US 2025/0335776 A1
(43) Pub. Date: Oct. 30, 2025

(54) SYSTEM AND METHOD FOR TAILORING PROMPTS FOR GENERATIVE MODELS

(71) Applicant: TOYOTA RESEARCH INSTITUTE, INC., Los Altos, CA (US)

(72) Inventors: Francine R. CHEN, Menlo Park, CA (US); Scott CARTER, San Jose, CA (US); Alexandre Leo Stephen FILIPOWICZ, Mountain View, CA (US); Brandon HUYNH, Los Angeles, CA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 18/646,546

(22) Filed: Apr. 25, 2024

(51) Int. Cl. G06N 3/091

(52) U.S. Cl. CPC G06N 3/091

(57) ABSTRACT

A method for modifying prompts includes generating, via large language model, a first group of prompts based on receiving a first user prompt from a first user. The method also includes receiving, from the first user, a first input selecting a first selected prompt of the first group of prompts. The method further includes generating, via a first generative model, a first output based on the first user selecting the first selected prompt. The method still further includes receiving, from a second user, a first rating associated with the first output.

### BACKGROUND

### Field

Aspects of the present disclosure generally relate to generative models, and more specifically to systems and methods for tailoring prompts for generative models.

### Background

Generative models, such as generative artificial intelligence (AI) models, exemplify the capabilities of AI models trained on extensive datasets of pre-existing content (hereinafter referred to as training data). Based on this training, generative models may discern intricate patterns and establish meaningful connections within the training data and/or input data. When provided with a prompt, a generative model may create content in the form of text, images, and/or music in accordance with the training data and/or previous input data. The output is dependent on the prompt. In this process, the prompt acts as a directive, conveying the user's intention and setting parameters for the generative model's response. Poorly designed prompts, such as prompts that fail to articulate a user's objective, often result in poor quality outputs compared to prompts that are well designed.

Prompt design refers to crafting input queries or statements to properly articulate a user's objective, thereby guiding a generative model to produce a desired output. That is, a properly articulated prompt may improve the relevancy and accuracy of the generative model's output. Moreover, the specificity and clarity of the prompt may influence the efficiency of the generative model, reducing the need for multiple iterations of outputs. This precision in communication may improve an accuracy of an output from the generative model.

### SUMMARY

In one aspect of the present disclosure, a method for modifying prompts includes generating, via large language model, a first group of prompts based on receiving a first user prompt from a first user. The method also includes receiving, from the first user, a first input selecting a first selected prompt of the first group of prompts. The method further includes generating, via a first generative model, a first output based on the first user selecting the first selected prompt. The method still further includes receiving, from a second user, a first rating associated with the first output.

Another aspect of the present disclosure is directed to an apparatus including means for generating, via large language model, a first group of prompts based on receiving a first user prompt from a first user. The apparatus also includes means for receiving, from the first user, a first input selecting a first selected prompt of the first group of prompts. The apparatus further includes means for generating, via a first generative model, a first output based on the first user selecting the first selected prompt. The apparatus still further includes means for receiving, from a second user, a first rating associated with the first output.

In another aspect of the present disclosure, a non-transitory computer-readable medium with non-transitory program code recorded thereon is disclosed. The program code is executed by one or more processors and includes program code to generate, via large language model, a first group of prompts based on receiving a first user prompt from a first user. The program code additionally includes program code to receive, from the first user, a first input selecting a first selected prompt of the first group of prompts. The program code also includes program code to generate, via a first generative model, a first output based on the first user selecting the first selected prompt. The program code further includes program code to receive, from a second user, a first rating associated with the first output.

Other aspects of the present disclosure are directed to an apparatus for modifying prompts. The apparatus includes one or more processors, and one or more memories coupled with the one or more processors and storing processor-executable code that, when executed by the one or more processors, is configured to cause the apparatus to generate, via large language model, a first group of prompts based on receiving a first user prompt from a first user. Execution of the processor-executable code also cause the apparatus to receive, from the first user, a first input selecting a first selected prompt of the first group of prompts. Execution of the processor-executable code further cause the apparatus to generate, via a first generative model, a first output based on the first user selecting the first selected prompt. Execution of the processor-executable code still further cause the apparatus to receive, from a second user, a first rating associated with the first output.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram illustrating an example of a system generating content via a generative model, in accordance with various aspects of the present disclosure.

FIG. 2 is a diagram illustrating an example of a hardware implementation for a system, in accordance with various aspects of the present disclosure.

FIG. 3 illustrates a prompt bootstrapping pipeline, in accordance with various aspects of the present disclosure.

FIG. 4 illustrates a prompt tailoring pipeline, in accordance with various aspects of the present disclosure.

FIG. 5 is a flow diagram illustrating an example process for tailoring prompts for generative models, in accordance with various aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be broadly applicable to different technologies, system configurations, networks, and protocols, some of which are illustrated by way of example in the figures and in the following description of the preferred aspects. The detailed description and drawings are merely illustrative of the present disclosure rather than limiting, the scope of the present disclosure being defined by the appended claims and equivalents thereof.

As discussed, generative models identify patterns and form connections within both training data and input data. Generative models may generate outputs such as text, images, and music, with the effectiveness of these outputs significantly influenced by the design of an input prompt provided to the generative model. Prompt design may be used to tailor the input prompt in a manner that properly conveys the user's intent. As a result, relevance and accuracy of the generative model's output may be improved. Prompt design may also improve the generative model's efficiency by reducing the amount of output iterations to achieve a desired output.

Generative models lack built-in mechanisms to guide users on how variations in a prompt may affect an output. Predicting the relationship between specific prompts and the resulting media may be inherently challenging, as the inner workings of most generative models are not transparent. Nonetheless, it may be desirable to assist users in refining their prompts to produce outcomes that align more closely with an intended output.

Various aspects of the present disclosure are directed to methods for tailoring prompts for a generative model such that an output of the generative model is in accordance with an intended output. In some examples, a large language model generates a first group of prompts based on an initial prompt. After a first user selects a prompt from the first group of prompts, a generative model may generate an output based on the selected prompt. A second user may then rate the output. Then, the initial prompt, the selected prompt, and the rating may be stored in a database.

After the database includes a specified quantity of prompts and ratings, a second group of prompts may be generated based on the stored prompts, ratings, and a new prompt provided by the first user. The first user may then select a prompt from the second group of prompts. The generative model may then generate an output based on the selected prompt. The second user may rate the output, and the rating, the selected prompt, and the new prompt may be stored in the database for future iterations.

Particular aspects of the subject matter described in this disclosure can be implemented to realize one or more of the following potential advantages. In some examples, the described techniques, such as tailoring a prompt based on previous prompts and ratings, enable a generative model to modify prompts to meet the specifications of a given application. Other advantages include enabling a user to obtain a desired output despite the user being unfamiliar with a style pertaining to the output. For example, a user may be a generally un-empathetic person, and so the user may implement various techniques described in this disclosure to produce prompts that better produce outputs that are more empathetic.

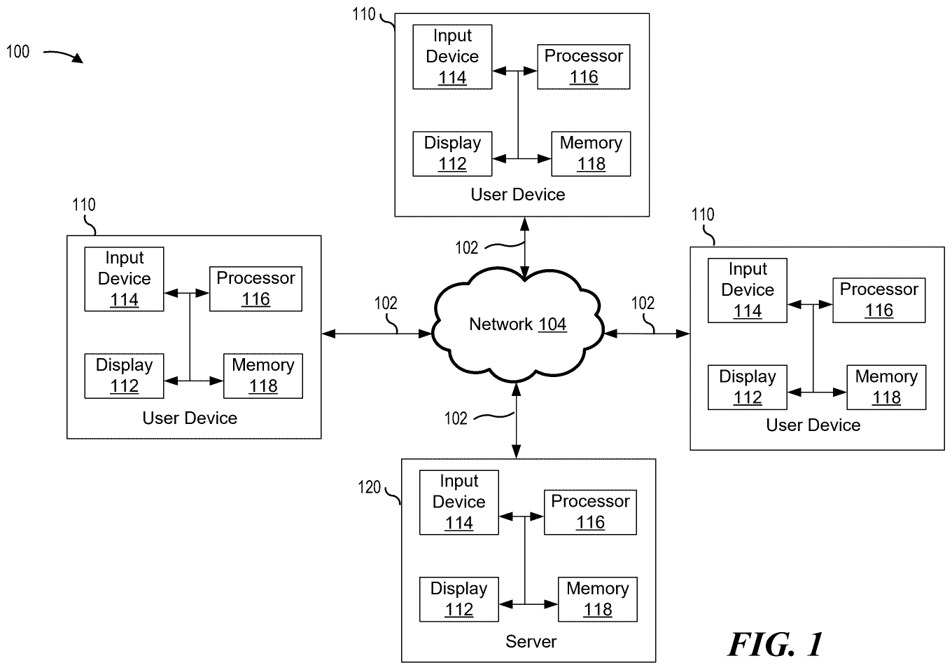

FIG. 1 is a block diagram illustrating an example of a system 100 generating content via a generative model, in accordance with aspects of the present disclosure. As shown in the example of FIG. 1, the system 100 may include one or more user devices 110 and one or more servers 120. For ease of explanation, only one server 120 is shown in the example of FIG. 1. Each user device 110 may be connected to a network 104 via one or more communication links 102. The communication links 102 may be wired and/or wireless communication links. The server 120 may also be connected to the network 104 via a communication link 102.

The network 104 may be an example of the Internet. Additionally, or alternatively, the network 104 may include any suitable computer network such as an intranet, a wide-area network (WAN), a local-area network (LAN), a wireless network, a digital subscriber line (DSL) network, a frame relay network, an asynchronous transfer mode (ATM) network, and/or a virtual private network (VPN). The communication links 102 may be any type of communication link that may be suitable for communicating data between user devices 110 and the server 120. For example, the communication links 102 may network links, dial-up links, wireless links (e.g., Wi-Fi link, satellite link, or cellular communication link), and/or hard-wired links.

The server 120 may be a computing device, such as a server, processor, computer, cloud computing device, cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to host a generative model and communicate via a wireless or wired medium. In some examples, the server 120 may host a generative model. In some such examples, one or more server 120 may work in tandem to host the generative model. Specifically, the server 120 may implement functions and/or computer code that runs the generative model and/or a site, such as a website, for accessing the generative model.

Each user device 110 may be an example of a personal computing device, a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium. A user device 110 may be used by a user to input a prompt to a generative model via an interface associated with the generative model. The interface may be accessed via a website or a dedicate application, such as a mobile phone application. Additionally, or alternatively, the user device 110 may store the generative model, and the user may input a prompt via an interface associated with the stored generative model. In some examples, each user device 110 shown in FIG. 1 may be used by a different user. Each user device 110 and server 120 may be stationary or mobile.

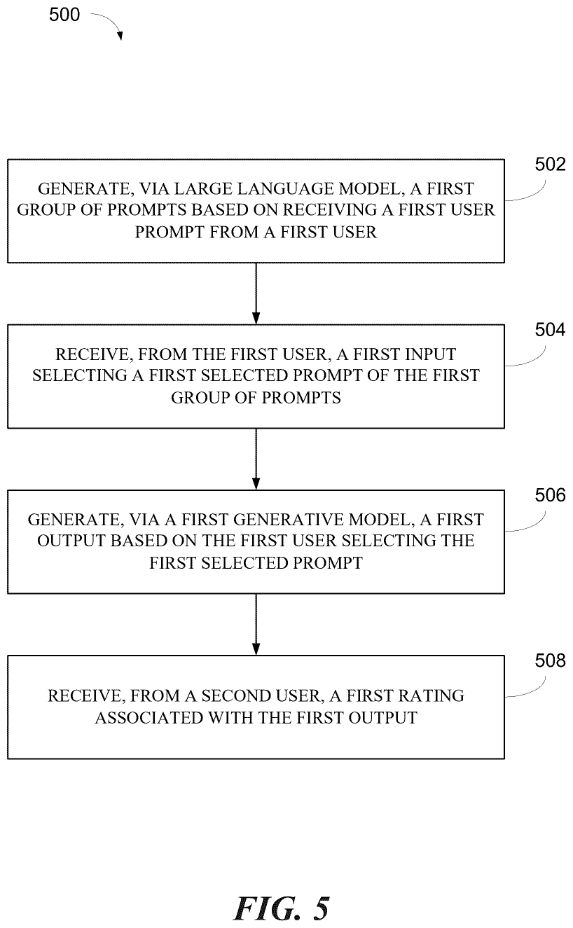

In some examples, each user device 110 may be included inside a housing that houses components of the user device 110, such as one or more processors 116 and a memory 118. The housing may also include, or be connected to, a display 112 and an input device 114, which may be interconnected with other components of the user device 110. For case of explanation, only one processor 116 is shown for each user device 110. In some examples, the one or more processors 116, the display 112, the input device 114, and the memory 118 may be interconnected via a bus architecture. The memory 118 may include one or more different types of memory, such as random access memory (RAM), static RAM (SRAM), dynamic RAM (DRAM), and/or another type of memory. Each user device 110 may also include a storage device (not shown in the example of FIG. 1), such as a hard disk (e.g., non-transitory computer readable medium). In some examples, the memory 118 and/or the storage device include program code (e.g., instructions) that may be executed by the processor 116 to control one or more functions of the user device 110. The input device 114 may be used to navigate the interface associated with the generative model, provide input to a prompt tailoring module, and/or perform other tasks. Working in conjunction with one or more components of the user device 110, the processor 116 may receive information associated with the generative model, and control the display 112 to output information associated with the generative model. The display 112 may output (e.g., display) information received at the processor 116. In some examples, the processor 116 of the user device 110 is configured to perform operations and implement one or more elements associated with one or more processes, such as the process 500 described with respect to FIG. 5.

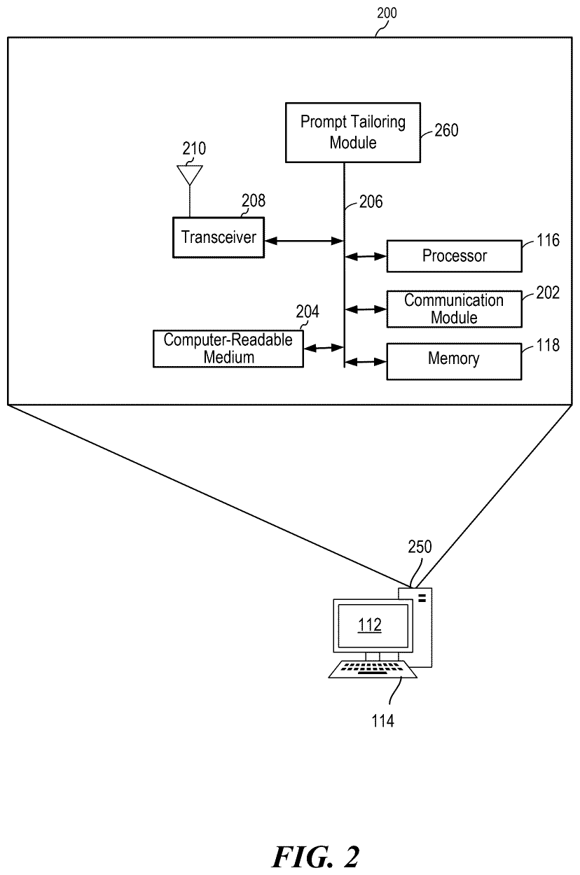

In some examples, a generative AI host may maintain the server 120. The server 120 may be included inside a housing that houses components of the server 120, such as one or more processors 116 and a memory 118. The housing may also include, or be connected to, a display 112 and an input device 114, which may be interconnected with other components of the user device 110. For case of explanation, only one processor 116 is shown for the server 120. In some examples, the one or more processors 116, the display 112, the input device 114, and the memory 118 may be interconnected via a bus architecture. The memory 118 may include one or more different types of memory, such as RAM, SRAM, DRAM, and/or another type of memory. The server 120 may also include a storage device (not shown in the example of FIG. 1), such as a hard disk (e.g., non-transitory computer readable medium). In some examples, the memory 118 and/or the storage device include program code (e.g., instructions) that may be executed by the processor 116 to control one or more functions of the server 120. For example, the processor 116 may execute instructions for maintaining the generative model, training the generative model, and/or executing the generative model. In some examples, the processor 116 of the server 120 is configured to perform operations and implement one or more elements associated with one or more processes, such as the process 500 described with respect to FIG. 5. Additionally, or alternatively, the processor 116 of the server 120 may be configured to perform operations associated with the prompt tailoring module 260 described with reference to FIG. 2.

FIG. 2 is a diagram illustrating an example of a hardware implementation for a system 200, according to various aspects of the present disclosure. The system 200 may be a component of a device 250. The device 250 may be an example of a user device 110 or a server 120 described with reference to FIG. 1. As shown in the example of FIG. 2, the device 250 may include a display 112 and an input device 114 (e.g., a keyboard). In some examples, the system 200 is configured to perform operations and implement one or more elements associated with one or more processes, such as the process 500 described with reference to FIG. 5.

The system 200 may be implemented with a bus architecture, represented generally by a bus 206. The bus 206 may include any number of interconnecting buses and bridges depending on the specific application of the system 200 and the overall design constraints. The bus 206 links together various circuits including one or more processors and/or hardware modules, represented by a processor 116, and a communication module 202. The bus 206 may also link various other circuits such as timing sources, peripherals, voltage regulators, and power management circuits, which are well known in the art, and therefore, will not be described any further.

The system 200 includes a transceiver 208 coupled to the processor 116, the communication module 202, and the computer-readable medium 204. The transceiver 208 is coupled to an antenna 210. The transceiver 208 communicates with various other devices over a transmission medium, such as a communication link 102 described with reference to FIG. 1. For example, the transceiver 208 may receive commands via transmissions from a user or a remote device.

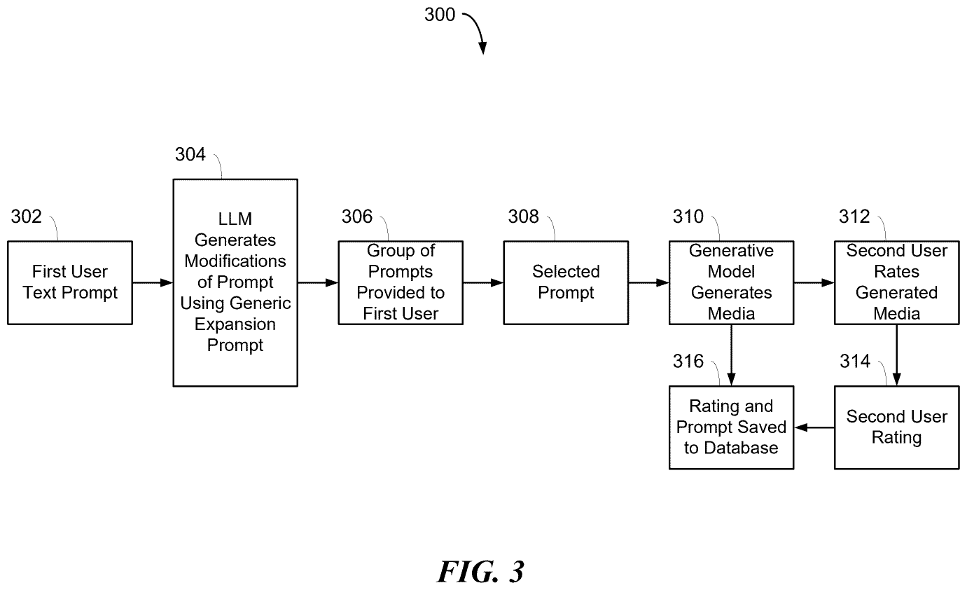

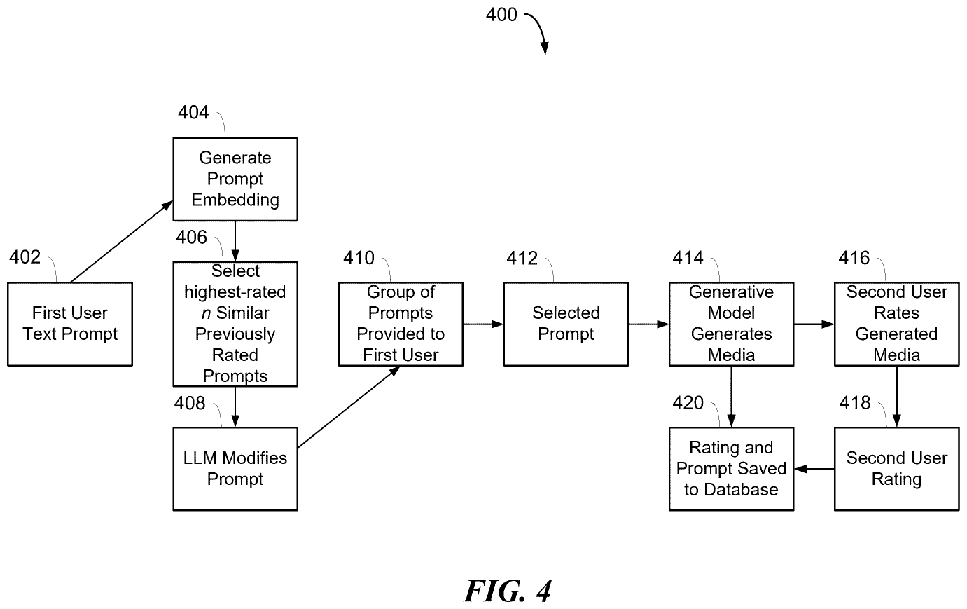

As shown in the example of FIG. 2, the system 200 may include a prompt tailoring module 260 that may be trained to perform one or more tasks associated with refining a prompt provided for a generative model. For example, the prompt tailoring module 260 may be trained to perform the tasks described with reference to the one or more modules or engines described with reference to FIGS. 3 and 4. The prompt tailoring module 260 may include artificial or computational intelligence elements, such as, neural network, fuzzy logic, or other machine learning algorithms. In one or more arrangements, one or more of the other modules 116, 118, 202, 204, 208, can also include artificial or computational intelligence elements, such as, neural network, fuzzy logic, or other machine learning algorithms. Further, in one or more arrangements, one or more of the modules 116, 118, 202, 204, 208 can be distributed among multiple modules 116, 118, 202, 204, 208, 260 described herein. In one or more arrangements, two or more of the modules 116, 118, 202, 204, 208, 260 of the system 200 can be combined into a single module.

The system 200 includes the processor 116 coupled to the computer-readable medium 204. The processor 116 performs processing, including the execution of software stored on the computer-readable medium 204 providing functionality according to the disclosure. The software, when executed by the processor 116, causes the system 200 to perform the various functions described for a particular device, such as any of the modules 116, 118, 202, 204, 208, 260. For example, when executed by the processor 116, the software causes the system 200 and/or the prompt tailoring module 260 to implement one or more elements associated with one or more processes, such as the process 500 described with respect to FIG. 5. The computer-readable medium 204 may also be used for storing data that is manipulated by the processor 116 when executing the software. For example, working in conjunction with one or more of the other modules the modules 116, 118, 202, 204, and 208, the prompt tailoring module 260 may perform one or more functions, such as one or more functions of the process 500 described with reference to FIG. 5.

As indicated above, FIGS. 1 and 2 are provided as examples. Other examples may differ from what is described with regard to FIGS. 1 and 2.

As discussed, generative models enable users to generate media from text prompts. Generative models can be tuned with a wide variety of parameters-including guidance scales, target regions, grounding images, or grounding text. Still, in most cases, the nature of the generated outputs is influenced by the text prompt provided to the generative model. Despite text prompts playing such a significant role in determining the final output of a generative model, conventional systems for implementing generative models do not include guidance to help users understand how different prompts influence generated outputs. In fact, the manner in which generative models interpret prompts is often poorly understood, even by those that regularly use generative models. Amongst this lack of understanding, it may be desirable to help users modify their prompts to generate an output that best matches the needs of a particular application.

Aspects of the present disclosure are directed to techniques for tailoring prompts for generative models. Various techniques described in the disclosure may combine offline modeling with a human-in-the-loop collaborative system to generate text prompts that match a particular application. In some examples, a user is directed to generate media that shows empathy with another user. The user may implement a prompt design process that has access to ratings of empathy for previously generated media. The prompt design process may use past successes to modify current prompts to be more empathetic. A set of the prompt modifications may be provided to participants so that the participants may select a prompt modification that best matches the participant's intent. The participant may additionally edit the prompt modification.

FIG. 3 illustrates an example of a pipeline for a first prompt modification process 300, in accordance with various aspects of the present disclosure. The first prompt modification process 300 may be performed by the processor 116 described with reference to FIG. 1, or the prompt tailoring module 260 described with reference to FIG. 2. As illustrated in FIG. 3, the first prompt modification process 300 begins by receiving a text prompt 302 from a first user. The text prompt may include instructions as to the type and nature of an output (e.g., media) that the first user would like to have generated by a first generative model (e.g., large language model). After receiving the text prompt 302, a generic prompt module 304 generates a group of prompts based on the text prompt 302. In some examples, the generic prompt module 304 may implement a second generative model, such as a second large language model, to generate the group of prompts. The second generative model may be trained to generate prompts. In some examples, the generic prompt module 304 may use a generic prompt to modify the text prompt 302. The generic prompt may be a prompt that includes a directive to improve the text prompt 302. An example generic prompt is as follows: “What follows is a prompt for an AI image generator. Can you help improve it? Here is the prompt: ABC,” where ABC is the text prompt 302.

The generic prompt module 304 may generate a group of prompts 306 based on the generic prompt and text prompt 302, the group of prompts 306 including one or more generated prompts. The first prompt modification process 300 may then provide the group of prompts 306 to the first user. The first user, upon receiving the group of prompts 306, may select a prompt 308 from the group of prompts 306. For example, the first user may select their most preferred prompt, or a prompt that the first user determines to meet some criteria. The first user may additionally edit the selected prompt 308. After editing the selected prompt 308, the selected prompt 308 is then provided to a media generation module 310.

The media generation module 310 may generate media based on receiving the selected prompt 308. To generate the media, the media generation module 310 may implement a generative model. The generative model may be, for example, a generative adversarial network (GAN), variational autoencoder (VAE), generative pre-trained transformer (GPT), recurrent neural network (RNN), or any other generative model configured to generate media as an output. Examples of media include text, images, music, videos, and three-dimensional models. The generated media is then provided to a rating module 312, and the selected prompt 308 and text prompt 302 are provided to a database module 316. The database module 316 may store the prompt 308 and the text prompt 302 in a database or other memory.

In some examples, the rating module 312 is associated with a user interface. In such examples, a user may provide, via the user interface, a rating 314 based on the generated media. The rating 314 may be stored in the database and/or other memory by the database module 316. In some implementations, a second user may rate the generated media based on the second user's preference and/or other criteria. For example, the criteria may be the generated media's applicability to a theme. As one example, the second user may rate the generated media based on the media evoking an emotion or concept, such as empathy, melancholy, freedom, awe, politeness, respectfulness, or authority. The rating 314 may then be provided to the database module 316. Although the second user may be a human, it is contemplated that the second user may be a program, such as an AI model, trained to rate the generated media. It is also contemplated that the rating module 312 may receive ratings from one or more humans and/or one or more generative models. In some examples, the rating module 312 may provide an aggregate rating based on the ratings from the one or more humans and/or the one or more generative models.

After receiving the text prompt 302, the selected prompt 308, and the rating 314, the database module 316 stores the text prompt 302, selected prompt 308 and the rating 314 in the database. The text prompt 302, the selected prompt 308, and the rating 314 are each associated with one another in the database. If the database module 316 receives more than one rating from the rating module 312, each rating is stored in the database and associated with the text prompt 302 and the selected prompt 308. For case of explanation, text prompts stored in the database, such as the text prompt 302, may be referred to as stored text prompts. Selected prompts stored in the database, such as the selected prompt 308, may be referred to as stored selected prompts. Stored text prompts and stored selected prompts may be collectively referred to as stored prompts. Similarly, ratings stored in the database, such as the rating 314, may be referred to as stored ratings.

The first prompt modification process 300 may perform any number of iterations for generating prompts, rating the prompts, and storing the prompts, selected prompts, and ratings in the database. In each iteration, the first prompt modification process 300 may perform the techniques illustrated and described with respect to FIG. 3. Although the first user and the second user may each be the same user in each iteration, it is contemplated that the first user and the second user may each be different users for each iteration.

FIG. 4 illustrates an example of a pipeline for a second prompt modification process 400, in accordance with various aspects of the present disclosure. The second prompt modification process 400 may be performed by the processor 116 described with reference to FIG. 1, or the prompt tailoring module 260 described with reference to FIG. 2. In some implementations, the device performing the first prompt modification process 300 may perform the second prompt modification process 400 once a condition is satisfied. For example, the processor 116 may perform the first prompt modification process 300 until the quantity of prompts stored by the database module 316 becomes greater than a threshold. Once the quantity of prompts is greater than the threshold, the processor 116 may perform the second prompt modification process 400. For example, the processor 116 may identify a subset of prompts stored by the database module 316 that are related to a text prompt. The threshold may be configurable. For example, the processor 116, or any device implementing the first prompt modification process 300, may instead perform the second prompt modification process 400 once the quantity of stored selected prompts is greater than twenty.

The second prompt modification process 400 begins by receiving a text prompt 402 from a first user. Upon receiving the text prompt 402, an embedding module 404 generates an embedding (e.g., a numerical representation) based on the text prompt 402. The embedding module 404 may also create embeddings based on the prompts stored in a database, for example, prompts stored in the database by the database module 316 described with reference to FIG. 3. For example, the embedding module 404 may generate embeddings for the stored text prompts and/or the stored selected prompts. After the embedding module 404 generates the embeddings, a comparison module 406 identifies a subset of prompts stored in the database based on each stored prompt's associated rating and/or relatedness to the text prompt 402.

To determine the relatedness of stored prompts to the text prompt 402, the comparison module 406 may implement embedding tools to estimate the text prompt's 402 relatedness to each stored prompt. For instance, after the embedding module 404 converts the text prompt 402 into a numerical representation, the comparison module 406 may compare the numerical representation with numerical representations of each stored prompt using distance or similarity metrics, such as cosine similarity. The comparison module 406 may then identify a quantity of stored prompts that are most similar to the text prompt 402. For example, the comparison module 406 may identify five prompts that are most similar to the text prompt 402. In identifying prompts based on relatedness, the comparison module 406 may only determine the relatedness of the text prompt 402 to a stored text prompt, or the comparison module may only determine the relatedness of the text prompt 402 to a stored selected prompt.

As discussed, the comparison module 406 may also identify stored prompts based on respective stored ratings associated with each stored prompt. In some implementations, the comparison module 406 may only identify stored prompts that have a rating that is greater than a threshold. In some other implementations, the comparison module 406 may identify a quantity of stored prompts with the highest rating. For example, the comparison the comparison module 406 may identify only the twenty highest-rated stored selected prompts.

The comparison module 406 may first identify stored prompts based on a rating, and then narrow the group of prompts based on relatedness. For example, the comparison module 406 may first identify a first quantity of stored prompts that are above a rating threshold, these prompts may be referred to as “good prompts.” Then, the comparison module 406 may identify, from the good prompts, a quantity N of prompts that are most related to the text prompt 402. It is also contemplated that the comparison module 406 may first identify stored prompts based on relatedness, and then narrow the group of identified prompts based on rating. For example, the comparison module 406 may first identify a first quantity of stored prompts that are most related to the text prompt 402, then the comparison module 406 may identify, from the first quantity of stored prompts, a second quantity of prompts that are most highly rated.

Once the comparison module 406 identifies a subset of stored prompts based on rating and relatedness, a prompt module 408 generates one or more prompts 410 based on the identified subset of stored prompts and the text prompt 402. In some implementations, the prompt module 408 generates the group of prompts 410 by providing, to a generative model (e.g., a large language model), the identified stored prompts as examples, along with the text prompt 402. In some examples, the prompt module 408 may generate the one or more prompts using a few-shot learning approach. In some such examples, the prompt module 408 may receive the following input:
“What follows are examples of prompts and improved prompts for an AI image generator. The prompts are as follows: original prompt|improved prompt, original prompt|improved prompt, and so on. Here are the examples: stored text prompt|stored selected prompt, stored text prompt|stored selected prompt . . . . Based on that information, can you improve another original prompt? Here is the original prompt to improve: text prompt.”

In this example, stored text prompt refers to a stored text prompt identified by the comparison module 406 and stored selected prompt refers to a stored selected prompt identified by the comparison module 406. Each associated pair of stored prompts is separated by a vertical bar. Further, the text prompt refers to the text prompt 402.

As discussed, the prompt module 408 may generate the one or more prompts 410 via a generative model. For example, a GPT model may generate the one or more prompts 410 based on the identified subset of stored prompts and the text prompt 402. After the prompt module 408 generates the one or more prompts 410, a user, such as the user that provided the text prompt 402, selects a prompt 412 from the one or more prompts 410. The user may edit the selected prompt 412 before providing the selected prompt 412 to either a media generation module 414 or to the embedding module 404, thereby restarting the second prompt modification process 400.

The media generation module 414 may generate media based on receiving the selected prompt 412. In some examples, the media generation module 414 may implement a generative model to generate the media. The generative model may be, for example, a generative adversarial network (GAN), variational autoencoder (VAE), generative pre-trained transformer (GPT), recurrent neural network (RNN), or any other generative model configured to generate media as an output. Examples of media include text, images, music, videos, and/or three-dimensional models. The generated media is then provided to a rating module 416, and the selected prompt 412 and the text prompt 402 are provided to a database module 420.

In some examples, the rating module 416 is associated with a user interface. In such examples, a user may provide, via the user interface, a rating 418 based on the generated media. The rating 418 may be stored in the database and/or other memory by the database module 420. In some implementations, a second user may rate the generated media based on the second user's preference or some other criteria. The criteria may be the generated media's applicability to a theme. For instance, the second user may rate the generated media based on the media evoking an emotion or concept, such as empathy, melancholy, freedom, awe, politeness, respectfulness, or authority. The rating 418 may then be provided to the database module 420. Although the second user may be a human, it is contemplated that the second user may be a program configured to rate the generated media. For example, the second user may be a generative model tasked with rating generated media. It is also contemplated that the rating module 416 may implement ratings from one or more humans and/or one or more generative models. The rating module 416 may provide an aggregate rating based on the ratings from one or more humans and/or one or more generative models.

After receiving the text prompt 402, the selected prompt 412, and the rating 418, the database module 420 stores the text prompt 402, the selected prompt 412, and the rating 418 in a database. The text prompt 402, the selected prompt 412, and the rating 418 are each associated with one another in the database. If the database module 420 receives more than one rating from the rating module 416, each rating is stored in the database and associated with the text prompt 402 and the selected prompt 412. The second prompt modification process 400 may perform any number of iterations for generating prompts, rating the prompts, and storing the prompts, selected prompts, and ratings in the database. In each iteration, the second prompt modification process 400 may perform the techniques illustrated and described with respect to FIG. 4.

Although the first prompt modification process 300 and the second prompt modification process 400 are described as two separate pipelines, it is contemplated that the first prompt modification process 300 and second prompt modification process 400 may have common components. For example, the database module 316 of the first prompt modification process 300 and the database module 420 of the second prompt modification process 400 may be the same component and/or may utilize the same database. Similarly, the media generation module 310 of the first prompt modification process 300 and the media generation module 414 of the second prompt modification process 400 may implement the same generative model.

As discussed, the first prompt modification process 300 and the second prompt modification process 400 may additionally implement any quantity of users. For example, a single user may provide the text prompt 302 and rating 314 to the first prompt modification process 300 as well as the text prompt 402 and rating 418 to the second prompt modification process 400. In some examples, a first user may provide the text prompt 302 to the first prompt modification process 300. A second user may provide the rating 314 to the first prompt modification process 300. A third user may provide the text prompt 402 to the second prompt modification process 400, and a fourth user may provide the rating 418 to the second prompt modification process 400.

In some implementations, the first prompt modification process 300 and/or the second prompt modification process 400 may search for and identify text examples substantially similar to a text prompt. The pipeline may present the examples to a user to help the user write a prompt. For instance, the first prompt modification process 300 may identify one or more text examples that are substantially similar to the text prompt 302. Then, the first prompt modification process 300 may provide the one or more text examples to a user, and the user may submit a new prompt as the text prompt 302. The pipeline may additionally, or alternatively, provide the examples to a prompt generation module as an example of style. For example, the first prompt modification process 300 may provide the one or more text examples to the generic prompt module 304, and the generic prompt module 304 may generate prompts based on the text prompt 302 and the one or more text examples.

As discussed, various aspects of the present disclosure are directed to a process for refining prompts to better align with intended outputs. In some examples, the process includes generating a set of prompts from an initial prompt, selecting prompts for output generation, and rating these outputs. Such interactions are stored in a database to refine future prompts. This iterative process aims to improve the ability of generative models to produce more relevant and desired outcomes, even allowing users unfamiliar with certain styles to achieve outputs that better match their intentions, like creating more empathetic responses.

This iterative refinement process serves multiple advantages. It not only enables the tailoring of prompts to achieve highly specific and intended outputs but also democratizes the use of generative models. Users, irrespective of their familiarity with the nuances of the model's output style or their ability to empathize with the content, can leverage these methods to produce outputs that better reflect their intended outcome. For instance, a user lacking in empathy can still generate outputs that are perceived as empathetic, showcasing the potential of these techniques to bridge gaps between user capability and desired generative model performance.

The essence of the described process is to make generative models more accessible and effective for users, regardless of their prior experience or understanding of the model's underlying mechanics. By creating a feedback loop that incorporates user ratings of model outputs and uses these ratings to refine future prompts, the system can progressively improve the quality and relevance of its outputs. This approach not only enhances the user experience by making models more responsive to user needs but also expands the practical applications of generative models by enabling users to achieve specific, nuanced outputs that may not be possible through direct, unguided interaction with the model.

FIG. 5 is a flow diagram illustrating an example process 500 for tailoring prompts for generative models, in accordance with various aspects of the present disclosure. The example process 500 is an example of modifying prompts. In some examples, the example process 500 may be performed by a processor, such as the processor 116 described with respect to FIG. 1, or a prompt tailoring module 260 described with respect to FIG. 2. As shown in FIG. 5, the process 500 begins at block 502 by generating, via large language model, a first group of prompts based on receiving a first user prompt from a first user. In some implementations, the first group of prompts is generated in response to a second prompt received at the large language model. For instance, the processor 116 may receive a generic prompt and a text prompt. The processor 116 may then generate the first group of prompts based on the generic prompt and text prompt.

At block 504, the process 500 receives, from the first user, a first input selecting a first selected prompt of the first group of prompts. For instance, the first user may select their most preferred prompt of the first group of prompts, or a prompt that the first user determines to meet some criteria. The first user may additionally edit the selected prompt. At block 506, the process 500 generates, via a first generative model, a first output based on the first user selecting the first selected prompt. The first output may be media, such as text, images, music, videos, or three-dimensional models.

At block 508, the process 500 receives, from a second user, a first rating associated with the first output. The rating may be based on the second user's preference or some other criteria. For example, the second user may rate the first output based on the first output evoking some emotion or concept, such as empathy, melancholy, freedom, awe, politeness, respectfulness, or authority. The first rating may then be provided to a database module for storage or further processing.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor configured to perform the functions discussed in the present disclosure. The processor may be a neural network processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. The processor may be a microprocessor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or such other special configuration, as described herein.

The steps of a method or algorithm described in connection with the present disclosure may be embodied directly in hardware, in a software module executed by a processor, or in a combination of the two. A software module may reside in storage or machine-readable medium, including random access memory (RAM), read only memory (ROM), flash memory, erasable programmable read-only memory (EPROM), electrically erasable programmable read-only memory (EEPROM), registers, a hard disk, a removable disk, a CD-ROM or other optical disk storage, magnetic disk storage or other magnetic storage devices, or any other medium that can be used to carry or store desired program code in the form of instructions or data structures and that can be accessed by a computer. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Software shall be construed to mean instructions, data, or any combination thereof, whether referred to as software, firmware, middleware, microcode, hardware description language, or otherwise.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functions described throughout this present disclosure. Those skilled in the art will recognize how best to implement the described functionality for the processing system depending on the particular application and the overall design constraints imposed on the overall system.

The machine-readable media may comprise a number of software modules. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any storage medium that facilitates transfer of a computer program from one place to another. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means, such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for modifying prompts, comprising:
generating, via large language model, a first group of prompts based on receiving a first user prompt from a first user;
receiving, from the first user, a first input selecting a first selected prompt of the first group of prompts;
generating, via a first generative model, a first output based on the first user selecting the first selected prompt; and
receiving, from a second user, a first rating associated with the first output.

2. The method of claim 1, further comprising:
identifying a subset of stored prompts from a set of stored prompts based on receiving a second user prompt from a third user, each stored prompt of the subset of stored prompts associated with a rating;
generating a second group of prompts based on the subset of stored prompts and the second user prompt;
receiving, from the third user, a second input selecting a second selected prompt of the second group of prompts;
generating, via a second generative model, a second output based receiving the second input selecting the second selected prompt; and
receiving, from a fourth user, a second rating associated with the second output.

3. The method of claim 2, wherein the subset of stored prompts are identified based on an embedding of the second user prompt.

4. The method of claim 2, wherein the subset of stored prompts identified based on the respective rating of each stored prompt in the set of stored prompts.

5. The method of claim 2, wherein the subset of stored prompts is identified based on a quantity of stored prompts in the set of stored prompts being greater than a stored prompt threshold.

6. The method of claim 2, wherein the first user is the same user as the third user and/or the second user is the same user as the fourth user.

7. The method of claim 1, wherein:
the large language model is trained to generate the first group of prompts; and
the first group of prompts is generated in response to a second prompt received at the large language model.

8. An apparatus for modifying prompts, comprising:
one or more processors; and
one or more memories coupled with the one or more processors and storing processor-executable code that, when executed by the one or more processors, is configured to cause the apparatus to:
generate, via large language model, a first group of prompts based on receiving a first user prompt from a first user;
receive, from the first user, a first input selecting a first selected prompt of the first group of prompts;
generate, via a first generative model, a first output based on the first user selecting the first selected prompt; and
receive, from a second user, a first rating associated with the first output.

9. The apparatus of claim 8, wherein execution of the processor-executable code further causes the apparatus to:
identify a subset of stored prompts from a set of stored prompts based on receiving a second user prompt from a third user, each stored prompt of the subset of stored prompts associated with a rating;
generate a second group of prompts based on the subset of stored prompts and the second user prompt;
receive, from the third user, a second input selecting a second selected prompt of the second group of prompts;
generate, via a second generative model, a second output based receiving the second input selecting the second selected prompt; and
receive, from a fourth user, a second rating associated with the second output.

10. The apparatus of claim 9, wherein the subset of stored prompts are identified based on an embedding of the second user prompt.

11. The apparatus of claim 9, wherein the subset of stored prompts identified based on the respective rating of each stored prompt in the set of stored prompts.

12. The apparatus of claim 9, wherein the subset of stored prompts is identified based on a quantity of stored prompts in the set of stored prompts being greater than a stored prompt threshold.

13. The apparatus of claim 9, wherein the first user is the same user as the third user and/or the second user is the same user as the fourth user.

14. The apparatus of claim 8, wherein:
the large language model is trained to generate the first group of prompts; and
the first group of prompts is generated in response to a second prompt received at the large language model.

15. A non-transitory computer-readable medium having program code recorded thereon for modifying prompts, the program code executed by one or more processors and comprising:
program code to generate, via large language model, a first group of prompts based on receiving a first user prompt from a first user;
program code to receive, from the first user, a first input selecting a first selected prompt of the first group of prompts;
program code to generate, via a first generative model, a first output based on the first user selecting the first selected prompt; and
program code to receive, from a second user, a first rating associated with the first output.

16. The non-transitory computer-readable medium of claim 15, wherein the program code further comprises:
program code to identify a subset of stored prompts from a set of stored prompts based on receiving a second user prompt from a third user, each stored prompt of the subset of stored prompts associated with a rating;
program code to generate a second group of prompts based on the subset of stored prompts and the second user prompt;
program code to receive, from the third user, a second input selecting a second selected prompt of the second group of prompts;
program code to generate, via a second generative model, a second output based receiving the second input selecting the second selected prompt; and
program code to receive, from a fourth user, a second rating associated with the second output.

17. The non-transitory computer-readable medium of claim 16, wherein the subset of stored prompts are identified based on an embedding of the second user prompt.

18. The non-transitory computer-readable medium of claim 16, wherein the subset of stored prompts identified based on the respective rating of each stored prompt in the set of stored prompts.

19. The non-transitory computer-readable medium of claim 16, wherein the subset of stored prompts is identified based on a quantity of stored prompts in the set of stored prompts being greater than a stored prompt threshold.

20. The non-transitory computer-readable medium of claim 16, wherein the first user is the same user as the third user and/or the second user is the same user as the fourth user.
